(19) United States
(12) Patent Application Publication
(10) Pub. No.: US 2017/0173782 A1
(43) Pub. Date: Jun. 22, 2017

(54) MODULAR TOOLBOX

(71) Applicant: A-TINA TOOLS CO., LTD., TAICHUNG CITY (TW)

(72) Inventor: KUN-CHEN CHEN, TAICHUNG CITY (TW)

(21) Appl. No.: 14/973,665

(22) Filed: Dec. 17, 2015

(51) Int. Cl. B25H 3/02

(52) U.S. Cl. CPC B25H 3/028

(57) ABSTRACT

A modular toolbox has an accessory box and a main box. The accessory box has a baseboard, four supporting arms, two side boards, and an upright board. The four supporting arms are connected to four corners of the baseboard, and the two side boards engage with the baseboard. Each one of the two side boards engages with two adjacent ones of the supporting arms. The upright board engages with the baseboard and engages with the two adjacent supporting arms. The main box is fixed on the accessory box and has a casing. The casing is fixed on top surfaces of the four supporting arms, and the bottom surface of the casing engages with the two side boards and the upright board. A receiving space is formed between the accessory box and the main box for accommodating other toolboxes.

### BACKGROUND OF THE INVENTION

1. Field of the Invention

The present invention relates to a toolbox, and more particularly to a modular toolbox that may carry other toolboxes.

2. Description of Related Art

A conventional toolbox is used to store different kinds of metal hand tools, and the conventional toolbox has a handle. The handle of the conventional toolbox is convenient for users to carry the conventional toolbox. However, a hand of a user can only carry one conventional toolbox with the handle at one time. Therefore, the number of the carried conventional toolboxes is limited for the user, and the conventional toolbox should be improved.

To overcome the shortcomings of the conventional toolbox, the present invention provides a modular toolbox to mitigate or obviate the aforementioned problem.

### SUMMARY OF THE INVENTION

The main objective of the present invention is to provide a modular toolbox which may carry multiple toolboxes at the same time.

The modular toolbox has an accessory box and a main box. The accessory box has a baseboard, four supporting arms, two side boards, and an upright board. The four supporting arms are connected to four corners of the baseboard, and the two side boards engage with the baseboard. Each one of the two side boards engages with two adjacent ones of the supporting arms. The upright board engages with the baseboard and engages with the two adjacent supporting arms. The main box is fixed on the accessory box and has a casing. A bottom surface of the casing is fixed on top surfaces of the four supporting arms, and the bottom surface of the casing engages with the two side boards and the upright board. A receiving space is formed between the accessory box and the main box. Therefore, other toolboxes can be placed in the receiving space.

Other objects, advantages, and novel features of the invention will become more apparent from the following detailed description when taken in conjunction with the accompanying drawing.

### BRIEF DESCRIPTION OF THE DRAWINGS

FIG. 1 is a perspective view of a modular toolbox in accordance with the present invention;

FIG. 2 is an exploded perspective view of the modular toolbox in FIG. 1;

FIG. 3 is another exploded perspective view of the modular toolbox in FIG. 1;

FIG. 4 is an exploded perspective view of an accessory box of the modular toolbox in FIG. 1;

FIG. 5 is an enlarged perspective view of the accessory box of the modular toolbox in FIG. 1;

FIG. 6 is a front side view in partial section of the accessory box of the modular toolbox in FIG. 1; and

FIG. 7 is an operational perspective view of the modular toolbox in FIG. 1.

### DETAILED DESCRIPTION OF PREFERRED EMBODIMENT

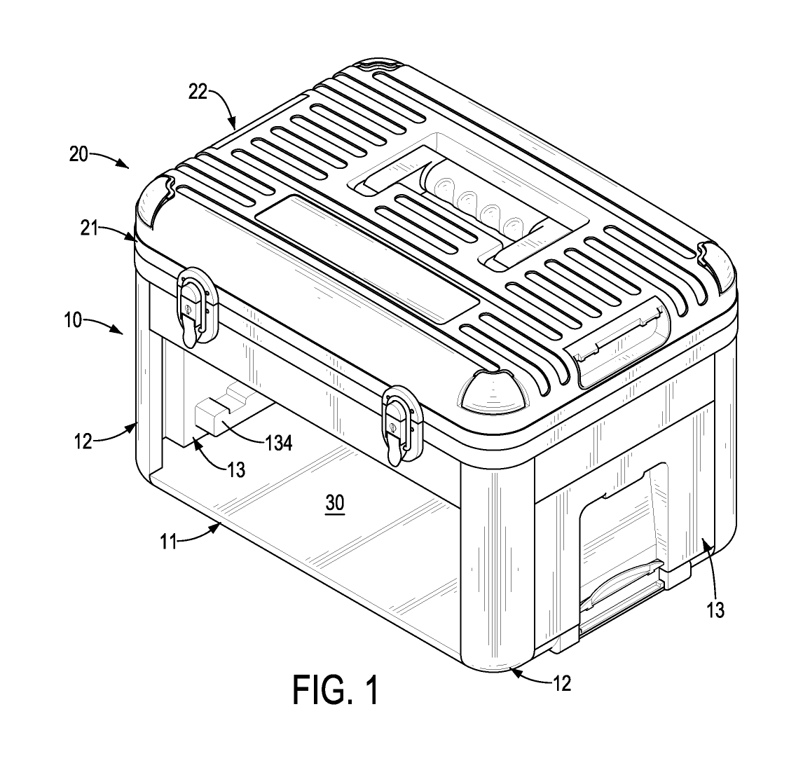

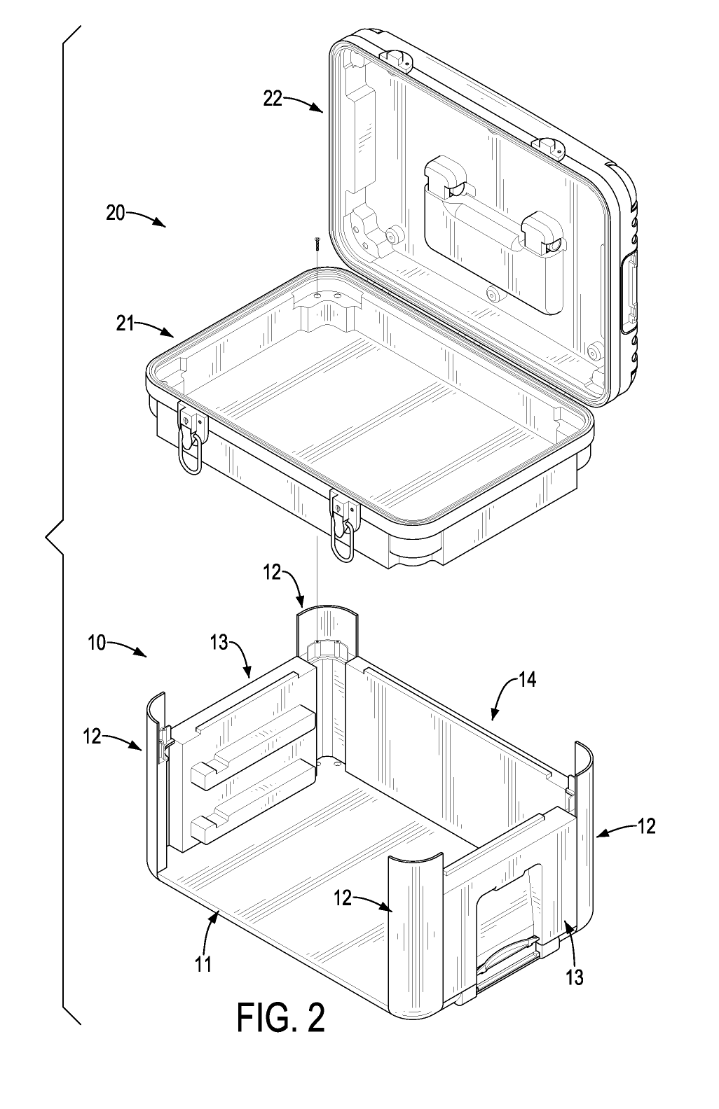

With reference to FIGS. 1 to 3, a modular toolbox in accordance with the present invention comprises an accessory box 10 and a main box 20.

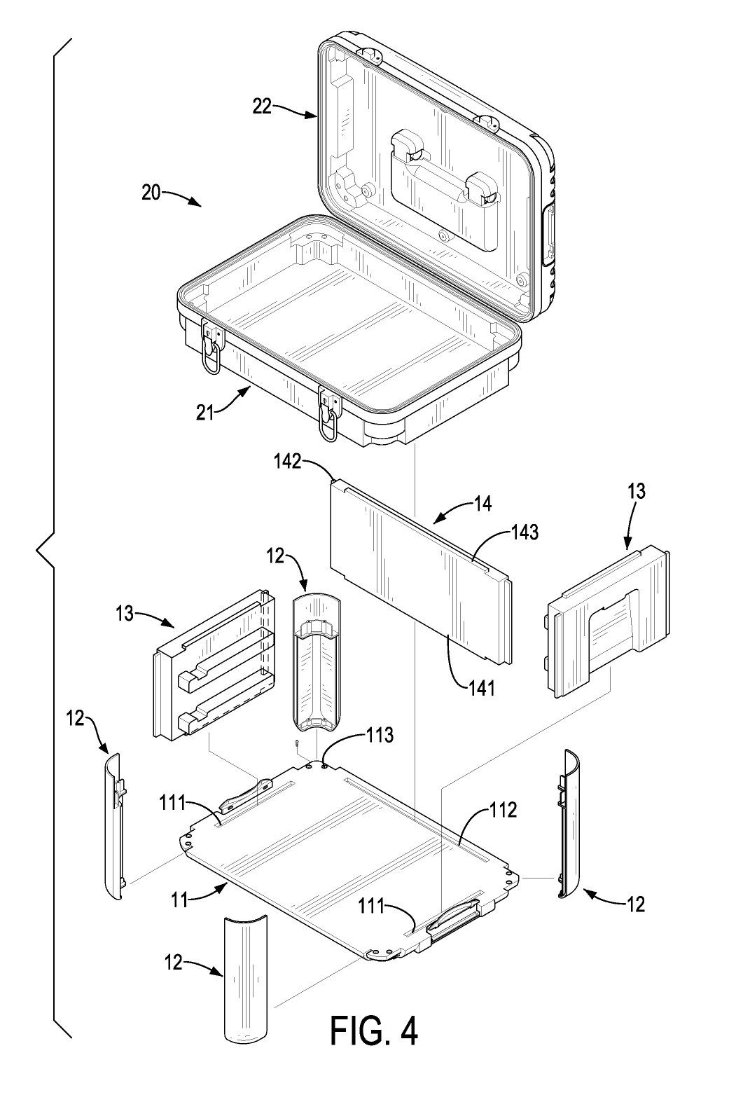

The accessory box 10 has a baseboard 11, four supporting arms 12, two side boards 13, and an upright board 14. The baseboard 11 is a horizontally disposed rectangular board and has a top surface. The top surface of the baseboard 11 has two long edges, two short edges, two first mounting recesses 111, a second mounting recess 112, four corners, and at least four through holes 113. With reference to FIG. 4, the two first mounting recesses 111 are formed in the top surface of the baseboard 11 respectively adjacent to the two short edges of the top surface of the baseboard 11, and the second mounting recess 112 is formed in the top surface of the baseboard 11 adjacent to one of the two long edges of the top surface of the baseboard 11. Each one of the two first mounting recesses 111 is parallel to one of the two short edges of the top surface of the baseboard 11, and the second mounting recess 112 is parallel to one of the two long edges of the top surface of the baseboard 11. The at least four through holes 113 are respectively formed through the four corners of the baseboard 11. Preferably, the baseboard 11 may have two through holes 113 formed through each one of the four corners of the baseboard 11.

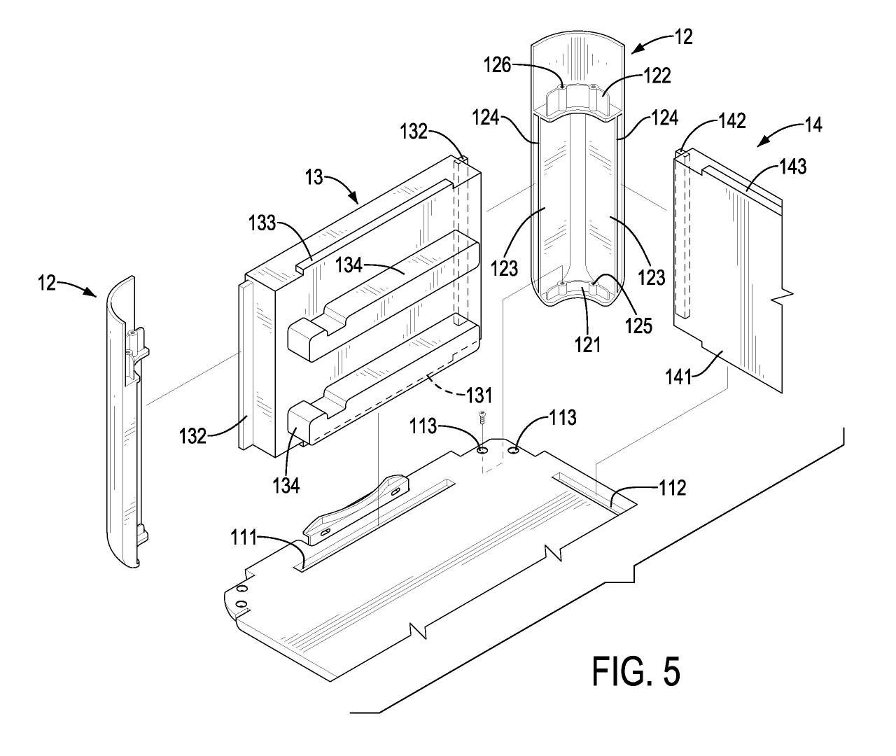

With reference to FIG. 5, the four supporting arms 12 are screwed with the baseboard 11. Each one of the four supporting arms 12 is an erect and arced board and has an inner surface, two side edges, a lower fastening portion 121, an upper fastening portion 122, two connecting sheets 123, and two connecting recesses 124. The lower fastening portion 121 is formed on and protrudes from a bottom of the inner surface of the supporting arm 12. The lower fastening portion 121 has two lower fastening holes 125, and the two lower fastening holes 125 are formed through the lower fastening portion 121 at a spaced interval. The two lower fastening holes 125 are screw holes. Because the connecting relationships between the four supporting arms 12 and the baseboard 11 are the same, a single supporting arm 12 will be described below. Two lower screws are mounted through the two through holes 113 of one of the four corners of the baseboard 11 and the two lower fastening holes 125 of the lower fastening portion 121, and this makes the supporting arm 12 screwed with the baseboard 11.

The upper fastening portion 122 is formed on and protrudes from a top of the inner surface of the supporting arm 12, and the upper fastening portion 122 has two upper fastening holes 126. The two upper fastening holes 126 are formed through the upper fastening portion 122 at a spaced interval. Each one of the two connecting sheets 123 is erect and has a side edge, and the side edge of each one of the two connecting sheets 123 is fixed on the inner surface of the supporting arm 12. The two connecting recesses 124 are respectively formed between the two connecting sheets 123 and the inner surface of the supporting arm 12. Two openings of each one of the two connecting recesses 124 respectively face the two side edges of the supporting arm 12. The two connecting recesses 124 are upright and elongated recesses.

The two side boards 13 are connected to the baseboard 11 and the four supporting arms 12. Each one of the two side boards 13 is an erect rectangular board. Each one of the two side boards 13 has a bottom surface, two side surfaces, a top surface, an inner surface, a lower positioning rib 131, two side positioning ribs 132, an upper positioning rib 133, and two placement tracks 134. The lower positioning rib 131 is formed on and protrudes downwardly from the bottom surface of the side board 13. The lower positioning rib 131 of the side board 13 engages with one of the two first mounting recesses 111 of the baseboard 11. Each one of the two side positioning ribs 132 is formed on and protrudes from one of the two side surfaces of each one of the two side boards 13. One of the two side positioning ribs 132 engages with the connecting recesses 124 of the two adjacent supporting arms 12. The upper positioning rib 133 is formed on and protrudes upwardly from the top surface of each one of the two side boards 13. The two placement tracks 134 may protrude from the inner surface of each one of the two side boards 13. The two placement tracks 134 are disposed vertically spaced at an interval, and the placement tracks 134 of the two side boards 13 face to each other, that is, an upper placement track 134 of one of the two side boards 13 faces an upper placement track 134 of the other side board 13

The upright board 14 is connected to the baseboard 11 and the two adjacent supporting arms 12 which are besides the second mounting recess 112, and the upright board 14 is located between the two side boards 13. The upright board 14 has a bottom surface, two side surfaces, a top surface, a lower fixing rib 141, two side fixing ribs 142, and an upper fixing rib 143. The lower fixing rib 141 is formed on and protrudes downwardly from the bottom surface of the upright board 14. The lower fixing rib 141 of the upright board 14 engages with the second mounting recess 112 of the baseboard 11. Each one of the side fixing ribs 142 is formed on and protrudes from one of the two side surfaces of the upright board 14. The two side fixing ribs 142 engage with the two adjacent supporting arms 12 which are besides the second mounting recess 112. The upper fixing rib 143 is formed on and protrudes upwardly from the top surface of the upright board 14.

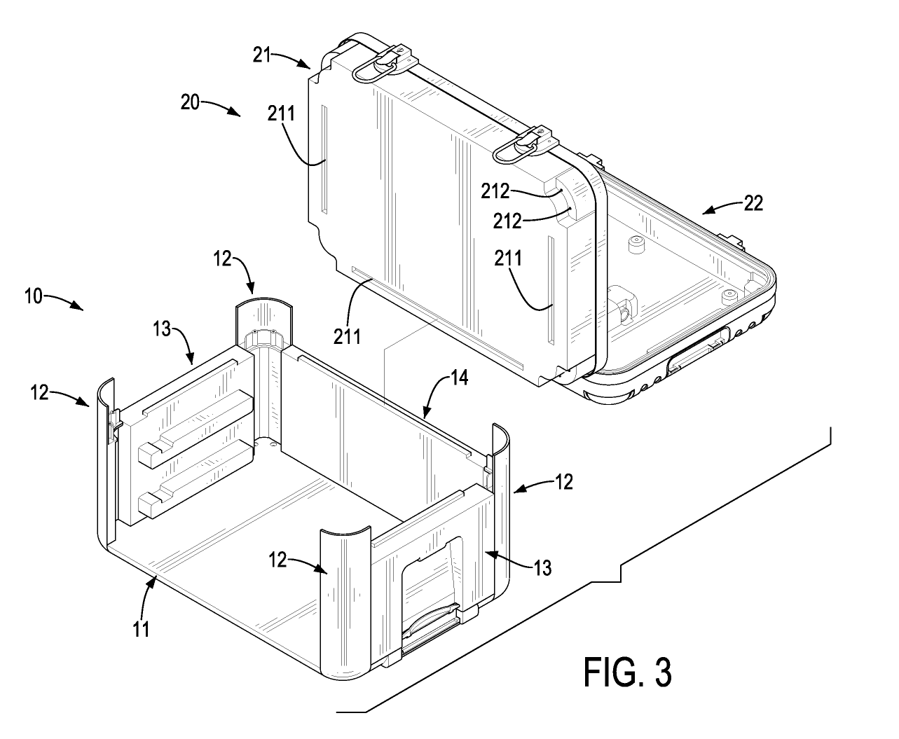

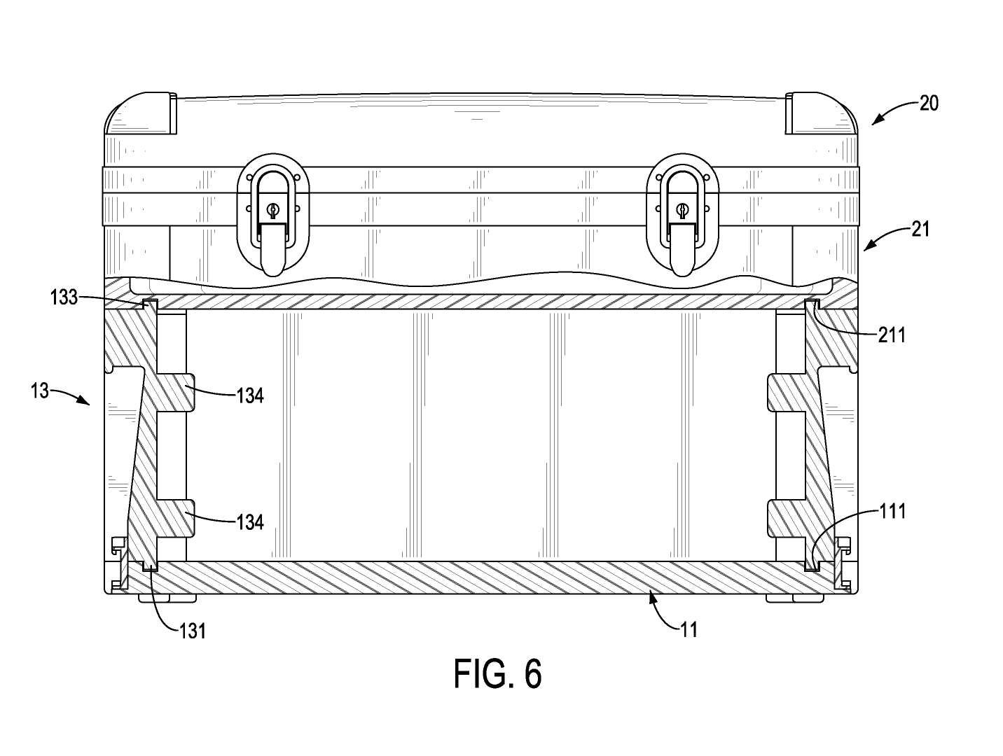

With reference to FIGS. 3 to 6, the main box 20 is fixed with the accessory box 10. The main box 20 has a casing 21 and a cover 22. The casing 21 has a bottom surface, three positioning recesses 211, four corners, and at least four connecting holes 212. The bottom surface of the casing 21 has four side edges. The three positioning recesses 211 are formed in the bottom surface of the casing 21 and are respectively adjacent to three of the four edges of the bottom surface of the casing 21. The three positioning recesses 211 are respectively disposed on the accessory box 10 above the three mounting recesses 111, 112. The upper positioning ribs 133 of the two side boards 13 and the upper fixing rib 143 of the upright board 14 respectively engage with the three positioning recesses 211 to connect the casing 21 with the two side boards 13 and the upright board 14. The at least four connecting holes 212 are formed through the four corners of the casing 21 respectively. Preferably, the casing 21 may have two connecting holes 212 formed through each one of the corners of the casing 21. Since the connecting relationships between the four supporting arms 12 and the casing 21 are the same, one single supporting arm 12 will be described below. Two upper screws are mounted through the two connecting holes 212 of one of the four corners of the casing 21 and the two upper fastening holes 126 of the upper fastening portion 122, and this makes the supporting arm 12 screwed with the casing 21. A receiving space 30 is formed between the baseboard 11, the four supporting arms 12, the two side boards 13, the upright board 14, and the casing 21. The cover 22 is pivotally connected to the casing 21.

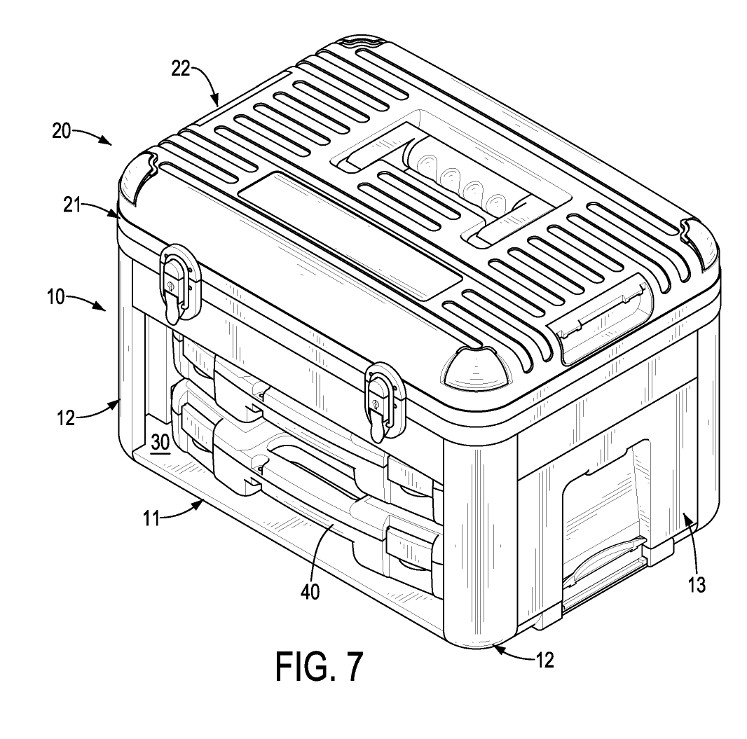

With reference to FIGS. 1 and 7, when the modular toolbox is in use, at least one toolbox 40 may be placed in the receiving space 30, and the at least one toolbox 40 abuts the four placement tracks 134 of the two side boards 13. As the user may only carry one conventional toolbox by one single hand at one time, the number of the toolboxes carried is limited. The design of the accessory box 10 and the main box 20 forms the receiving space 30 between the accessory box 10 and the main box 20. Therefore, users may carry multiple toolboxes 40 by placing the toolboxes 40 in the receiving space 30, and the modular toolbox is convenient in use.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A modular toolbox comprising:
an accessory box having
a baseboard being horizontally disposed and having
a top surface; and
four corners;
four supporting arms being erect and respectively fixed on the four corners of the baseboard;
two side boards being erect, and each one of the two side boards having
a bottom surface connected to the top surface of the baseboard; and
two side edges connected to two adjacent ones of the supporting arms; and
an upright board connected to two of the four supporting arms between the two side boards and having a bottom surface connected to the top surface of the baseboard; and
a main box fixed with the accessory box and having
a casing fixed with the four supporting arms and having
a bottom surface connected to the four supporting arms, and a receiving space formed between the baseboard, the four supporting arms, the two side boards, and the upright board; and
a cover pivotally connected to the casing.

2. The modular toolbox as claimed in claim 1, wherein
each one of the two side boards has a top surface connected to the bottom surface of the casing; and
the upright board has a top surface connected to the bottom surface of the casing.

3. The modular toolbox as claimed in claim 2, wherein
the top surface of the baseboard has
two long edges;
two short edges;
two first mounting recesses formed in the top surface of the baseboard and being respectively adjacent to the two short edges of the top surface of the baseboard; and
a second mounting recess formed in the top surface of the baseboard and being adjacent to one of the two long edges of the top surface of the baseboard;
each one of the four supporting arms has
two side edges, and
two connecting recesses respectively formed in the two side edges of the supporting arm;
each one of the side boards engages with one of the two first mounting recesses and the second mounting recess, and each one of the side boards engages with the two connecting recesses of the two adjacent supporting arms that are adjacent to the two first mounting recesses; and
the upright board engages with the second mounting recess, and the upright board engages with the two connecting recesses of the two adjacent supporting arms that are adjacent to the two first mounting recesses.

4. The modular toolbox as claimed in claim 3, wherein
the casing has three positioning recesses formed in the bottom surface of the casing and respectively adjacent to three of four edges of the bottom surface of the casing, the three positioning recesses respectively disposed above the two first mounting recesses and the second mounting recess;
each one of the two side boards has
an upper positioning rib formed on and protruding upwardly from the top surface of the side board;
the upright board has
an upper fixing rib formed on and protruding upwardly from the top surface of the upright board; and
the upper positioning ribs of the two side boards and the upper fixing rib of the upright board respectively engage with the three positioning recesses.

5. The modular toolbox as claimed in claim 4, wherein
the baseboard has at least four through holes formed through the four corners of the baseboard respectively; and
each one of the four supporting arms has
an inner surface; and
a lower fastening portion protruding from a bottom of the inner surface of the supporting arm and having at least one lower fastening hole formed through the lower fastening portion; and
two lower screws mounted through the at least one through hole of one of the four corners of the baseboard and the at least one lower fastening hole of the lower fastening portion, and the supporting arms screwed with the baseboard.

6. The modular toolbox as claimed in claim 5, wherein
the casing has four corners;
the casing has at least four connecting holes formed through the four corners of the casing respectively; and
each one of the four supporting arms has
an upper fastening portion protruding from a top of the inner surface of the supporting arm and having at least one upper fastening hole formed through the upper fastening portion, two upper screws mounted through the at least one connecting hole of one of the four corners of the casing and the at least one upper fastening hole of the upper fastening portion, and the supporting arm screwed with the casing.

7. The modular toolbox as claimed in claim 1, wherein each one of the two side boards has
an inner surface; and
two placement tracks protruding from the inner surface of the side board, and the two placement tracks disposed vertically spaced at an interval.

8. The modular toolbox as claimed in claim 2, wherein each one of the two side boards has
an inner surface; and
two placement tracks protruding from the inner surface of the side board, and the two placement tracks disposed vertically spaced at an interval.

9. The modular toolbox as claimed in claim 3, wherein each one of the two side boards has
an inner surface; and
two placement tracks protruding from the inner surface of the side board, and the two placement tracks disposed vertically spaced at an interval.

10. The modular toolbox as claimed in claim 4, wherein each one of the two side boards has
an inner surface; and
two placement tracks protruding from the inner surface of the side board, and the two placement tracks disposed vertically spaced at an interval.

11. The modular toolbox as claimed in claim 5, wherein each one of the two side boards has
an inner surface; and
two placement tracks protruding from the inner surface of the side board, and the two placement tracks disposed vertically spaced at an interval.

12. The modular toolbox as claimed in claim 6, wherein each one of the two side boards has
an inner surface; and
two placement tracks protruding from the inner surface of the side board, and the two placement tracks disposed vertically spaced at an interval.
